(19) United States
(12) Patent Application Publication
(10) Pub. No.: US 2017/0290114 A1
(43) Pub. Date: Oct. 5, 2017

(54) ILLUMINATION DEVICE HAVING A LIGHT EMITTING SOURCE OPERATED VIA A CLAMPED SERIES RESONATOR CONVERTER

(71) Applicant: General Electric Company, Schenectady, NY (US)

(72) Inventors: John Stanley GLASER, Niskayuna, NY (US); Ramanujam Ramabhadran, Niskayuna, NY (US)

(21) Appl. No.: 15/628,774

(22) Filed: Jun. 21, 2017

Related U.S. Application Data
(63) Continuation of application No. 14/561,942, filed on Dec. 5, 2014.

(51) Int. Cl. H05B 33/08; H02M 1/42

(52) U.S. Cl. CPC H05B 33/0815; H02M 1/4241; Y02B 70/1491; H02M 1/4258; Y02B 70/126; H02M 2001/0058

(57) ABSTRACT

An illumination device is provided. The illumination device includes a light emitting source and a clamped series resonant converter (CSRC) coupled thereto. The CSRC includes a first rectifier to generate a direct current (DC) using an alternating current (AC) voltage. The CSRC further includes an inverter having a switching leg including a plurality of switches coupled in series and a diode leg having a plurality of diodes coupled in series. The diode leg is coupled in parallel with the switching leg. Furthermore, the inverter includes an inductor coupled to the switching leg and a capacitor coupled to the diode leg. The CSRC also includes a transformer coupled to the inverter, where a voltage developed across a primary winding of the transformer causes automatic power factor correction by drawing an input current flowing through the CSRC that is proportional to the AC voltage.

### CROSS-REFERENCE TO RELATED APPLICATIONS

This application is a continuation-in-part of U.S. application Ser. No. 14/561,942 filed on Dec. 5, 2014, the entire contents of which are hereby incorporated by reference.

### BACKGROUND

The invention generally relates to power converter system and, more particularly, to a power converter system applicable in an illumination device.

Conventional LED devices include a light emitting source coupled to the power converter assembly. The power converter assembly includes different configurations which may be used to supply power to the LED device. One such configuration includes a rectifier operatively coupled to a flyback converter. The rectifier receives alternating current (AC) power from a power source and converts the AC power to direct current (DC) power. The AC power is sinusoidal and varies with time which leads to ripples/variations in the DC power. Therefore, the flyback converter is coupled to the rectifier to convert the DC power generated by the rectifier to generate a constant DC power, which is supplied to the light emitting source.

However, using such a configuration results in a large size and increased cost of the LED device. Due to the size is the power converter configuration, an LED shell of corresponding size of the power converter is required which increases costs of the LED device. Moreover, the large size of the LED device increases weight of the LED device.

Hence, there is a need for an improved power conversion system.

### BRIEF DESCRIPTION

In accordance with one embodiment, an illumination device is provided. The illumination device includes a light emitting source. The illumination device further includes a clamped series resonant converter (CSRC) electrically coupled to the light emitting source. The CSRC includes a first rectifier configured to generate a direct current (DC) power from an input alternating current (AC) voltage of the first rectifier. The CSRC further includes an inverter coupled to the first rectifier and configured to receive the DC power from the first rectifier and generate an intermediate AC power. The inverter includes a switching leg having a plurality of switches coupled in series. The inverter further includes a diode leg having a plurality of diodes coupled in series, where the diode leg is coupled in parallel with the switching leg, and where the plurality of diodes includes a first diode and a second diode. Furthermore, the inverter includes an inductor coupled to the plurality of the switches and a capacitor coupled in parallel with the second diode to facilitate generation of the intermediate AC power, where a voltage across the capacitor is clamped at a level equivalent to a level of a DC voltage at an input of the inverter or zero via the first diode and a second diode. Moreover, the CSRC further includes transformer coupled to the inverter. The transformer includes a primary winding and a secondary winding, where the primary winding of the transformer is connected between the inductor and the capacitor, and where a voltage developed across the primary winding causes automatic power factor correction by drawing an input current flowing through the CSRC that is proportional to the AC voltage.

In accordance with another embodiment, a method for operating an illumination device is provided. The illumination device includes a CSRC electrically coupled between a light emitting source coupled to, where the CSRC includes an inverter having a plurality of switches. The method includes operating the plurality of switches of the inverter of the clamped series resonant converter at a fixed switching frequency for a predetermined time. The method further includes drawing an input current by the clamped series resonant converter from the power source in phase with an input voltage supplied by the power source to achieve an automatic power factor correction. Furthermore, the method includes applying a fixed voltage at an output of the clamped series resonant converter by the light emitting source. Moreover, the method includes regulating a load current flowing through the light emitting source based on the fixed switching frequency.

In accordance with yet another embodiment, an illumination device is provided. The illumination device includes a light emitting source. The illumination device further includes a CSRC electrically coupled to the light emitting source. The CSRC includes a first rectifier configured to generate a DC power from an input AC voltage of the first rectifier. The CSRC further includes an inverter coupled to the first rectifier and configured to receive the DC power from the first rectifier and generate an intermediate AC power. The inverter includes a plurality of switches. Further, the inverter includes an inductor coupled to the plurality of the switches and a capacitor coupled in parallel with one of the plurality of the switches to facilitate generation of the intermediate AC power, where a voltage across the capacitor is clamped at a level equivalent to a level of a DC voltage at an input of the inverter or zero. Moreover, the CSRC further includes transformer coupled to the inverter. The transformer includes a primary winding and a secondary winding, where the primary winding of the transformer is connected between the inductor and the capacitor, and where a voltage developed across the primary winding causes automatic power factor correction by drawing an input current flowing through the CSRC that is proportional to the AC voltage.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of an illumination device including a clamped series resonator converter (CSRC), in accordance with an embodiment of the present technique;

FIG. 2 is a graphical representation of control signals, an inductor current, a capacitor voltage, and a transformer voltage within the CSRC of FIG. 1, in accordance with an embodiment of the present technique;

FIG. 3 is a flow chart representing steps involved in a method for regulating current in an illumination device in accordance with an embodiment of the present technique;

FIG. 4 is a flow chart representing steps involved in a method for operating an illumination device in accordance with an embodiment of the present technique;

FIG. 5 is a schematic representation of another illumination device, in accordance with an embodiment of the technique; and

FIG. 6 is a schematic representation of yet another illumination device, in accordance with an embodiment of the technique.

### DETAILED DESCRIPTION

Embodiments of the present application include an illumination device and a method for illuminating the illumination device without using a feedback loop for regulating a current in the illumination device is provided. In accordance with some embodiments, the illumination device and the method for operating the illumination device advantageously provide a smaller gate driver circuit in comparison to gate driver circuits employed in the conventional illumination devices. Such smaller gate driver circuit is enabled due to a clamped series resonator converter which uses a smaller transformer, when compared to the conventional gate driver circuits. Therefore, use of the smaller gate driver circuits reduces size of the illumination device. Furthermore, the clamped series resonator converter provides automatic regulation of the load current that flows through a load such as a light emitting source without the need for regulation of the load current using the feedback loop. Such automatic regulation of the load current increases efficiency of the illumination device. Also, due to the omission of the feedback loop to regulate the load current, the clamped series resonator converter uses lesser components, which further reduces cost of the illumination device.

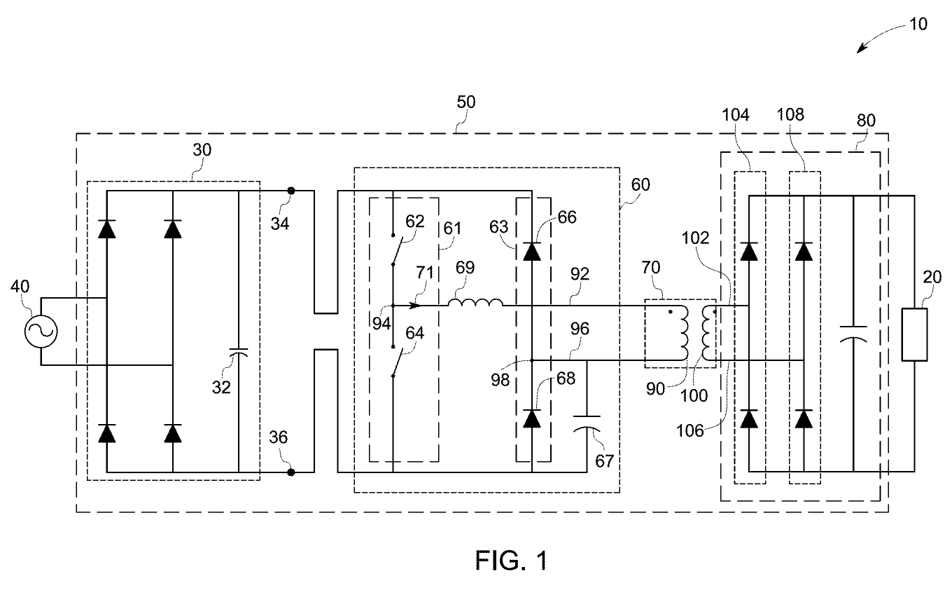

FIG. 1 is a schematic representation of an illumination device 10, in accordance with certain embodiments of the present application. The illumination device 10 includes a load 20, a power source 40, and a clamped series resonant converter (CSRC) 50. The power source 40 is coupled to the load 20 via the CSRC 50. The power source 40 may be a source of electricity which is capable of supplying an alternating current (AC) power, such as a utility electric power. The power source 40 supplies an input current (I_{g}) and an input voltage (V_{g}) to the CSRC 50.

As described herein, the load 20 may be a light emitting source that emits light when an electrical current is supplied thereto. In one embodiment, the light emitting source may include a string of one or more light emitting diodes (LEDs). In certain embodiments, the load 20 imposes a constant voltage on the CSRC 50 in an open loop operation of the illumination device 10. In the description, hereinafter the load 20 is described as an LED. Hereinafter, the load 20 is also alternatively referred to as an LED load 20.

The CSRC 50 operates as an AC-DC converter and generates a load current (i.e., a current flowing through the LED load 20) in response to a load voltage applied by the LED load 20. The CSRC 50 includes a first rectifier 30, an inverter 60, a transformer 70, and a second rectifier 80. The CSRC 50 is configured to generate a fixed output DC power which is supplied to the LED load 20.

The first rectifier 30 is an AC-DC power converter which is configured to convert an AC power received from a power source 40 into a DC power. For example, a DC voltage (V_{dc}) appears across output terminals 34, 36 of the first rectifier 30. The first rectifier 30 is shown as a full-wave diode bridge rectifier formed using four diodes. In one embodiment, the first rectifier 30 may include a high frequency filter coupled in parallel with the diode bridge. The high frequency filter may include a capacitor 32 coupled across the output terminals 34, 36 of the first rectifier 30, as shown in FIG. 1.

The inverter 60 is electrically coupled to the first rectifier 30 to receive power from the first rectifier 30. More particularly, the inverter 60 is coupled to the output terminals 34, 36 of the first rectifier 30 to receive the DC power from the first rectifier 30. The inverter 60 converts the DC power received from the first rectifier 30 to an intermediate AC power.

In the embodiment of FIG. 1, the inverter 60 includes a switching leg 61 and a diode leg 63. The switching leg 61 includes two switches 62, 64 operatively coupled to each other in series. Although, the switching leg 61 is shown as having two switches, the switching leg 61 may include more than two switches operatively coupled in series to each other. The diode leg 63 includes two diodes 66, 68 operatively coupled to each other in series. Although, the diode leg 63 is shown having two diodes, the diode leg 63 may include more than two diodes operatively coupled in series to each other. Moreover, the switching leg 61 and the diode leg 63 are coupled in parallel with each other. For example, the two series connected switches 62, 64 are coupled in parallel with the two series connected diodes 66, 68, as shown in FIG. 1. In one embodiment, each of the two switches 62, 64 may be semiconductor switches. Non-limiting examples of such semiconductor switches may include transistors, gate commutated thyristors, field effect transistors, insulated gate bipolar transistors, gate turn-off thyristors, static induction transistors, static induction thyristors, or combinations thereof. Moreover, materials used to form the semiconductor switch may include, but are not limited to, silicon (Si), germanium (Ge), silicon carbide (SiC), gallium nitride (GaN), gallium arsenide (GaAs), or combinations thereof. Moreover, the diodes 66 and 68 are not body diodes such as a body diode of a MOSFET but are both clamping diodes as well as current conducting diodes that operate for a long duration during the switching cycle to conduct a tank current. Therefore, these diodes 66, 68 not only serve as voltage clamps, but also serve as current directing elements, unlike the diodes used in traditional converters. The inverter 60 also includes a capacitor 67 and an inductor 69 configured to form a tank circuit in the inverter 60.

The inverter 60 receives the input DC voltage (V_{dc}) from the first rectifier 30. The input DC voltage (V_{dc}) appears across terminals 34, 36. The inverter 60 generates the intermediate AC power with an AC voltage, where a root mean square voltage of the AC voltage is equivalent to the load voltage. The two switches 62, 64 are switched based on a predetermined modulation technique in combination with the capacitor 67 and the inductor 69 to generate the intermediate AC power from the DC power. In one embodiment, the inverter 60 operates in a discontinuous mode of operation. In such an embodiment, voltage and the current pulses generated during the operation of the inverter 60 are determined by the inductor 69, the capacitor 67, the DC voltage and a duty cycle of the predetermined modulation technique. Therefore, an AC current component in the intermediate AC power generated by the inverter 60 at its output is controlled using a pulse rate determined by the predetermined modulation technique. Such control of the AC current component using the pulse rate enables controlling the inverter 60 based on a predetermined fixed switching frequency of the CSRC 50. Consequently, the CSRC 50 may be operated as a constant power source by only controlling the switching frequency of the CSRC 50 irrespective of the voltage and current component of the intermediate AC power. Such operation of the CSRC 50 at the predetermined fixed frequency enables an automatic power factor correction in the illumination device 10.

A traditional LED driver or AC-DC circuit generally includes two control loops, one for regulating the load current and one for shaping the input current. By using the CSRC 50, in accordance with some embodiments of the present specification, to control the LED load 20 as a function of frequency, power factor correction is automatically achieved, and one control loop can be eliminated. The characteristic of the CSRC 50 to operate as the automatic power factor corrector (described in greater detail below) allows the CSRC 50 to provide a fixed power at its output. Since the output power of the CSRC 50 is fixed and the load voltage is fixed, the load current flowing through the load also becomes constant. In one embodiment, the predetermined modulation technique may be chosen based on one or more criteria, where the one or more criteria may include a value representative of the AC power, a value representative of a power rating of the light emitting source, and a turn ratio of a transformer in the CSRC. In one embodiment, the inverter 60 in the CSRC 50 operates in a zero-voltage switching (ZVS) mode or a zero-current switching (ZCS) mode.

The CSRC 50 also includes a transformer 70 that is used to transfer the intermediate AC power generated by the inverter 60 to the second rectifier 80 operatively coupled to the transformer 70. The transformer 70 includes a primary winding 90 and a secondary winding 100. A first primary leg 92 of the primary winding 90 is operatively coupled to the two switches 62, 64 at a first primary node 94 and a second primary leg 96 is operatively coupled to the two diodes 66, 68 at a second primary node 98. The inductor 69 is operatively coupled to the first primary leg 92 and the capacitor 67 is operatively coupled to the second primary leg 96. Furthermore, the secondary winding 100 is operatively coupled the second rectifier 80 in the CSRC 50, where a first secondary leg 102 is operatively coupled to a first set 104 of diodes in the second rectifier 80 and a second secondary leg 106 is operatively coupled to a second set 108 of diodes in the second rectifier 80. The first set 104 and the second set 108 are connected in parallel to one another. The diodes in each of the first set 104 and the second set 108 are operatively coupled in series to each other.

During normal operation, the CSRC 50 is operated in ZCS mode. The resonant inductor 69 in the inverter 60 enables the CSRC 50 to operate in the ZCS mode. The ZCS mode is achieved based on a value of the inductor 69. A small value of the inductor 69 may lead to faster deterioration of current in the inductor 69 during a switching cycle when compared to a higher value of the inductor 69. However, the smaller value of the inductor 69 may lead to a decrease in a conduction time, and may subsequently result in a decrease in efficiency. Therefore, in order to achieve faster deterioration of current in the inductor 69 without reducing the efficiency, a turn ratio of the transformer 70 is maintained such that for the same inductor 69, a voltage at the inductor 69 may increase with respect to the transformer 70, which forces the current to deteriorate faster in the inductor 69. Such a configuration of the transformer 70 including the turn ratio corresponding to the inductor 69 reduces root mean square losses on the switches and increases efficiency of the CSRC 50.

The transformer 70 may further include a leakage inductance and a magnetizing inductance. The leakage inductance is induced in the CSRC 50 due to the parasitic behavior of the transformer 70. In embodiments, where a value of the leakage inductance of the transformer 70 is equivalent to the inductor 69, the inductor 69 may be replaced by the leakage inductance. Furthermore, the magnetizing inductance in the transformer 70 induces a magnetizing current 71 in the CSRC 50. Such magnetizing current 71 enables the CSRC 50 to operate in the ZVS mode and helps in recovering additional power.

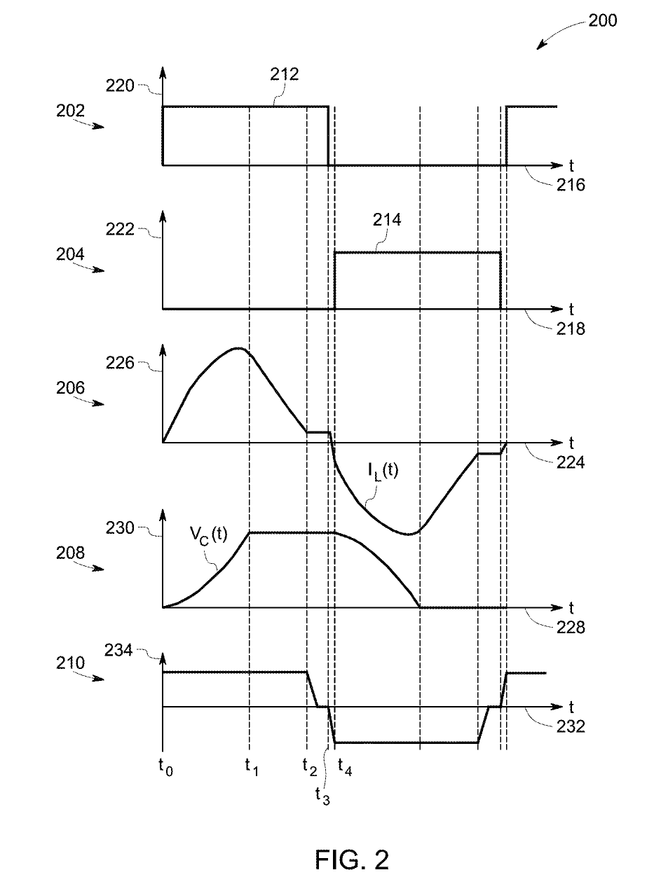

In some embodiment, the gate pulses (such as control signals in FIG. 2) for switching the two switches 62, 64 may be such that the switches 62, 64 switch from a conducting state to non-conducting state or vice versa, before the current in the inductor 69 reaches zero. In such conditions, switches 62, 64 achieve their ZCS boundary conditions and when the switches are in a non-conducting state, a voltage develops in the switches 62, 64 due to an inherent switch capacitance in the switches 62, 64. Subsequently, upon switching the switches to a conducting state, the CSRC 50 is unable to use such voltages to recover additional power resulting in losses, however, the magnetizing current 71 helps in recovering such lost power by using such voltages to deliver additional power to the light emitting source 20. Such recovery of the additional power further increases efficiency of the illumination device 10. In one embodiment, the CSRC 50 may operate in a partial ZVS mode or a full ZVS mode. The full ZVS mode may represent a condition where, the voltage at the switches 62, 64 during the switching of the switches 62, 64 is zero. However, the partial ZVS mode may represent a condition where, the magnetizing current is able to recover a portion of the lost power by reducing the voltage at the switches 62, 64 up to a certain limit which may correspond to the gate pulses.

In continuation to the operation of the transformer 70, as the first primary leg 102 and the second primary leg 106 of the transformer 70 are operatively coupled to the two switches 62, 64 and the two diodes 66, 68 of the inverter 60 respectively, the current pulses of the AC current component generated by the inverter 60 during its operation, flow within the primary winding 90. Such flow of current in the primary winding 90 induces a corresponding AC current pulse in the secondary winding 100 due to the magnetic coupling between the primary winding 90 and the secondary winding 100. In one embodiment, the corresponding AC current generated in the secondary winding 100 is based on a turn ratio of the transformer 70.

Such corresponding AC current pulses in the secondary winding 100 are used by the second rectifier 80 to convert the intermediate AC power to an output DC power. In such a scenario, since the load voltage is fixed and the CSRC 50 provides fixed power at a fixed predetermined frequency, the load current automatically remains constant. Such constant load current flows though the LED load 20 for illumination. Therefore, as described herein, the CSRC 50 receives the AC power from the power source 40 and converts the AC power to a fixed output DC power. Therefore, upon operatively coupling the CSRC 50 to the light emitting source 20, the load current in the illumination device 10 is regulated automatically without using a closed loop control for sensing and rectifying an error determined by a feedback loop. As discussed above, since the load voltage is fixed and the CSRC 50 provides a constant output DC power at a fixed predetermined switching frequency, the load current automatically becomes constant without the need for regulation.

A detailed operation of the CSRC 50 is described herein for the LED load 20. The LED load 20 imposes a constant voltage on the output of the second rectifier 80 when the CSRC 50 is operated in an open loop condition.

During operation, the switches 62 and 64 are operated by applying control signals having a fixed frequency at a 50% duty-cycle. When the switch 62 is turned ON, the capacitor 67 charges in a resonant manner. The charging current of the capacitor 67 or an inductor current flows from the terminal 34 of the first rectifier 30 to the terminal 36 of the first rectifier 30 via the switch 62, the inductor 69, the transformer 70, and the capacitor 67. The current (i_{L}(t)) through the inductor 69 (hereinafter referred to as an inductor current) and a voltage (v_{c}(t)) across capacitor 67 (hereinafter referred to as a capacitor voltage) may be represented using following equations:

$$\begin{matrix}{i}_{L} ( t ) = ω {C}_{r} ( {V}_{g} - {nV}_{o} ) sin ( ω t ) & Equation ( 1 ) \\ {v}_{c} ( t ) = ( {V}_{g} - {nV}_{o} ) \times ( 1 - cos ω t ) \\ where , \\ ω = \frac{1}{√ {L}_{r} {C}_{r }} , & Equation ( 2 )\end{matrix}$$

Cᵣ capacitance of the capacitor 67,
V_{g} represents an input voltage applied by the power source 40,
Vₒ represents voltage across the LED load 20,
n represents turns ratio of the transformer 70, and
nVₒ represents voltage across a primary winding 90 of the transformer 70, alternatively, also referred to as a reflected output voltage.

When the capacitor voltage (v_{c}(t)) across the capacitor 67 becomes equal to input DC voltage (V_{dc}) of the inverter 60, the inductor current (i_{L}(t)) starts freewheeling through the diode 66. The freewheeling of the inductor current (i_{L}(t)) through the diode 66 results in clamping of the capacitor voltage (v_{c}(t)) at a level equivalent to the input DC voltage (V_{dc}). Therefore, a net voltage applied across the inductor 69 is similar to the voltage across the primary winding 90 of the transformer 70 (nVₒ) which determines the time taken to reduce the current through the inductor 69 to zero.

The switch 62 turns OFF at 50% of a total cycle time (i.e., a reciprocal of the switching frequency). When the switch 62 turns OFF, the switch 64 turns ON for a second half of the cycle time. When the switch 64 turned ON and the switch 62 is turned OFF, the capacitor 67 discharges. The diode 68 clamps the capacitor voltage (v_{c}(t)) from going below zero and the inductor current (i_{L}(t)) flows through the diode 68 via the switch 64. Moreover, as the reflected output voltage (nVₒ) is applied across the inductor 69, the inductor current (i_{L}(t)) through diode 68 reduces to zero. It is to be noted that the current in the inductor 69 builds up when the capacitor 67 voltage is not clamped at either extreme, for example, the input DC voltage (V_{dc}) or zero. The inductor current (i_{L}(t)) ramps down to zero when the capacitor 67 is clamped either at the input DC voltage (V_{dc}) or at zero. In the period when the capacitor voltage (v_{c}(t)) is clamped, the voltage across the inductor 69 is equivalent to the reflected output voltage (nVₒ). Due to the load being an LED load 20, the reflected output voltage (nVₒ) voltage is maintained at a constant value.

Moreover, the current through the LED load 20 is determined by the switching frequency of the switches 62, 64. The power transferred to the LED load 20 is proportional to CᵣV_{g}²Fₛ. In case of the load being the LED load 20, the output voltage (i.e., voltage applied by the LED load 20) is fixed. Therefore, the load current, for example, the current flowing through the LED load 20 is dependent only on the switching frequency. Consequently, the load current may be adjusted by varying the switching frequency.

When the CSRC 50 is operated at constant switching frequency for the LED load 20, a total charge drawn (Qᵢₙ) by the CSRC 50 in every input cycle is represented by following equation:

Qᵢₙ=n×cᵣ×V_{g} Equation (3)

The equation (3) indicates that the input charge (Qᵢₙ) of the CSRC 50 is proportional to the input voltage (V_{g}) of the CSRC 50. As the input current (I_{g}) of the CSRC 50 is proportional to the product of the input charge (Qᵢₙ) and the switching frequency, a constant switching frequency makes the input current (I_{g}) of the CSRC 50 proportional to the input voltage (V_{g}) of CSRC 50. Such a behavior of the CSRC 50 which leads to the input current (I_{g}) of CSRC 50 being proportional to the input voltage (V_{g}) of CSRC 50 causes automatic power factor correction in the illumination device 10.

Additionally, the combination of the CSRC 50 converter with the LED load 20 advantageously leads to an open loop type operation for achieving a load regulation and power factor correction. In some embodiments, the output voltage is independent of the load current, and thus even with dimming of the LED, the switching frequency may be controlled to vary the current without affecting the flow of currents within the CSRC 50. Thus, the CSRC 50 can be regulated to provide a certain light output in an LED driver by controlling the frequency, while power factor correction is automatically achieved without a control loop. It is to be noted that for a given load current, the frequency is maintained constant through the AC line cycle.

FIG. 2 is a graphical representation 200 of the capacitor voltage (v_{c}(t)) and the inductor current (I_{L}(t)) within the CSRC 50 of FIG. 1, in accordance with one embodiment of the present technique. More particularly, the graphical representation 200 depicts variations in the capacitor voltage (v_{c}(t)) and the inductor current (I_{L}(t)) with respect to control signals applied to the switches 62, 64. The graphical representation 200 includes sub-graphs 202, 204, 206, 208, and 210. The sub-graphs 202, 204, 206, 208, and 210 respectively depict a time domain representation of a control signal 212 applied to the switch 62, a control signal 214 applied to the switch 64, the inductor current (I_{L}(t)), the capacitor voltage (v_{c}(t)), and a transformer voltage (Vₒ) (i.e., voltage across secondary winding 100 of the transformer 70).

In the sub-graphs 202 and 204, respective X-axes 216, 218 represent time while the respective Y-axes 220, 222 represent a level of the control signal. The control signals 212 and 214 are applied to control terminals (e.g., gate terminals) of the switches 62 and 64, respectively. In some embodiments, the duty-cycle of each of the control signals 212, 214 may be maintained at 50% while the frequency of the control signals 212, 214 may be varied to vary the load current. In some embodiments, the frequency of the control signals 212, 214 may be maintained constant for to achieve constant load current to vary light output by the LED load 20. In certain embodiments, duty cycle of the control signals 212, 214 may also be additionally varied to achieve finer control of the load current to vary light output by the LED load 20.

In the sub-graph 206 the X-axes 224 represents time while the Y-axes 226 represents a magnitude of the inductor current (I_{L}(t)). Moreover, in the sub-graph 208 the X-axes 228 represents time while the Y-axes 230 represents a magnitude of the capacitor voltage (v_{c}(t)). In the sub-graph 210 the X-axes 232 represents time while the Y-axes 234 represents a magnitude of the transformer voltage (Vₒ). Under an LED load such as the LED load 20, a constant voltage with opposite polarity in each half cycle is applied to the transformer 70 regardless of the output power. The application of such constant voltage results in a lower transformer stress compared to many topologies including a Flyback converter of similar power rating.

During operation of the CSRC 50, in the time duration t₀-t₁, the inductor current (I_{L}(t)) builds-up and the capacitor 67 charges. At time t₁, the capacitor voltage (v_{c}(t)) is clamped at the input DC voltage (V_{dc}) and the inductor current (I_{L}(t)) starts decreasing. The capacitor voltage (Mt)) remains clamped at the input DC voltage (V_{dc}) till time t₄. The inductor current (I_{L}(t)) during the interval t2-t3 is composed of the magnetizing current only as the voltage across the capacitor 67 is same as the input DC voltage (V_{dc}). The inductor current (I_{L}(t)) flows via the switch 62 as long as the control signal 212 to the switch 62 is high. When the control signal 212 reaches the low level (i.e., after time t3), the switch 62 turns OFF. When the switch 62 turns OFF, the magnetizing current discharges the charge stored in the capacitance associated with the switches 62 and 64, specifically at the junction of the two switches 62, 64. This results in partial or full ZVS for the switch 64, for example, in the interval t3-t4. A similar cycle occurs to ensure ZVS of the switch 62, as well. This results in lower loss for the CSRC 50.

The time intervals t₀ to t₁ and t₁ to t₂ are a function of the resonant tank parameters, the input AC voltage, and the load voltage. In some embodiments, the flat portion of the inductor current (I_{L}(t)) during t₂-t₃ indicates the role of the magnetizing current in providing an optional zero-voltage switching for the switches.

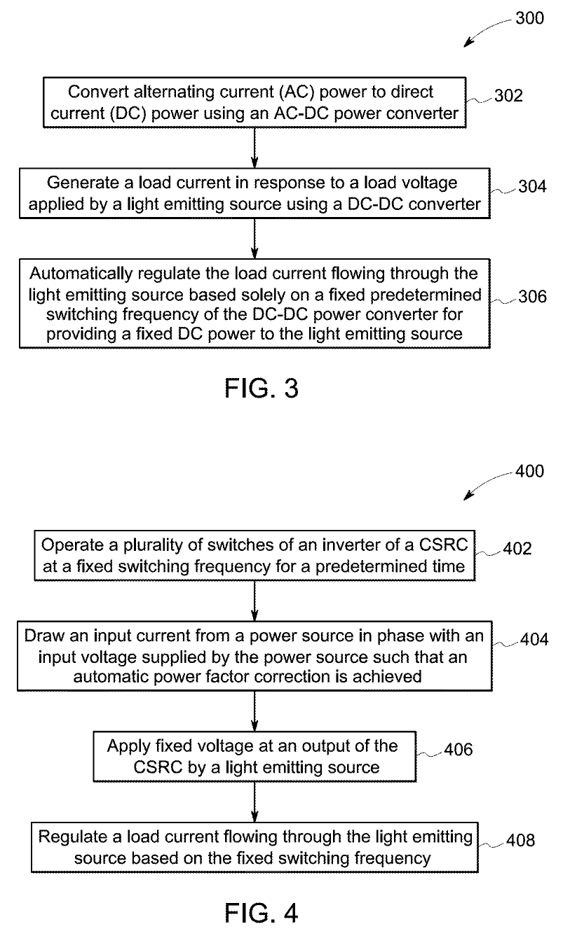

FIG. 3 is a flow chart representing a method 300 for regulating current in an illumination device such the illumination device 10 in accordance with certain embodiments. The method 300 includes converting alternating current (AC) power to direct current (DC) power using an AC-DC power converter in step 302. In one embodiment, a power factor corrector AC-DC power converter is used to convert the alternating current (AC) power to the direct current (DC) power. The method 300 also includes generating a load current in response to a load voltage applied by a light emitting source such as the LED load 20 using a DC-DC converter in step 304. In one embodiment, a clamped series resonator converter is used to generate the load current in response to the load voltage applied by the light emitting source. In a specific embodiment, the clamped series resonant converter is operated at the fixed predetermined switching frequency to provide an automatic power factor correction to DC power received from the AC-DC power converter for providing the fixed power to the light emitting source. In another embodiment, a magnetizing inductance is induced in the clamped series resonant converter for operating the clamped series resonant converter in a ZVS mode. In another embodiment, the clamped series resonant converter is operated in a ZVS upon achieving a ZCS boundary condition. In a specific embodiment, the clamped series resonant converter operates in a partial zero-voltage switching mode. The method 300 further includes automatically regulating the load current flowing through the light emitting source based solely on a fixed predetermined switching frequency of the DC-DC power converter for providing a fixed DC power to the light emitting source in step 306.

FIG. 4 is a flow chart representing a method 400 for operating an illumination device such the illumination device 10 in accordance with certain embodiments. The method 400, at step 402, includes operating the plurality of switches 62, 64 of the inverter 60 of the CSRC 50 at a fixed switching frequency for a predetermined time. To operate the plurality of switches 62, 64 at step 402, the control signals (e.g., the control signals 212, 214) are applied to respective control terminals of the plurality of switches 62, 64. As shown in FIG. 2, the control signals includes pulses of the fixed switching frequency. In one embodiment, the switches 62 and 64 are operated by applying control signals having a fixed frequency at a 50% duty-cycle. A switching frequency of the switches may be set to another fixed value depending on the load current required by the LED load 20.

Further, at step 404, the CSRC 50 draws/receives an input current (I_{g}) from the power source 40 in phase with an input voltage (V_{g}) supplied by the power source 40 such that an automatic power factor correction is achieved. As noted earlier, as the load is the LED load 20 and the switches 62, 64 are operated at fixed frequency, the input charge (Qᵢₙ) of the CSRC 50 is proportional to the input voltage (V_{g}). Therefore, operation of the inverter 60 at constant/fixed switching frequency makes the input current (I_{g}) of the CSRC 50 proportional to the input voltage (V_{g}) of the CSRC 50. Such a behavior of the CSRC 50 which leads to the input current (I_{g}) of the CSRC 50 being proportional to the input voltage (V_{g}) of the CSRC 50 causes automatic power factor correction in the illumination device 10.

Moreover, at step 406, a fixed voltage is applied at an output of the CSRC 50 by the light emitting source such as the LED load 20. For example, the LED load 20 imposes the fixed voltage at the output of the second rectifier 80. Additionally, at step 408, the CSRC 50 regulates the load current flowing through the light emitting source such as the LED load 20 based on the fixed switching frequency. As previously noted, the load current through the LED load 20 is determined by the switching frequency of the switches 62, 64. In case of the load being the LED load 20, the output voltage (i.e., the voltage applied by the LED load 20) is fixed. Therefore, the load current flowing through the LED load 20 is dependent only on the switching frequency. Consequently, the load current may be adjusted by varying the switching frequency.

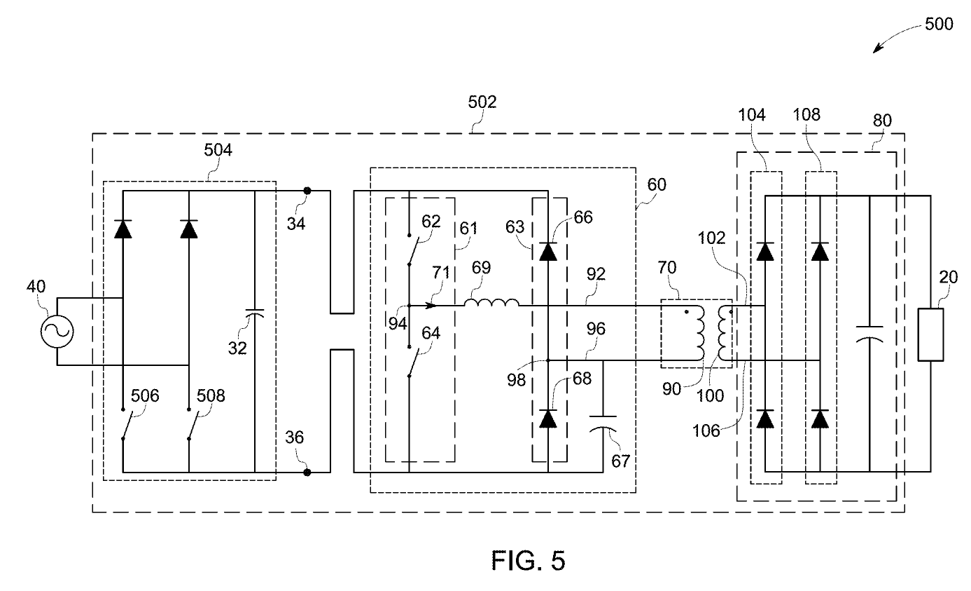

FIG. 5 is a schematic representation of an illumination device 500, in accordance with certain embodiments of the present application. The illumination device 500 includes the load 20, the power source 40, and a CSRC 502. The power source 40 is coupled to the load 20 via the CSRC 502. The CSRC 502 is representative of one embodiment of the CSRC 50 of FIG. 1. The CSRC 502 includes certain sub-systems such as the inverter 60, the transformer 70, and the second rectifier 80 that are similar to the corresponding sub-systems used in the illumination device 10 of FIG. 1. A first rectifier 504 of the CSRC 502 is different from the first rectifier 30 of the CSRC 50. More particularly, the first rectifier 504 of the CSRC 502 includes switches 508 and 510 in the positions of two bottom diodes of the first rectifier 30 of the CSRC 50. The switches 508 and 510 may be similar to the switches 62, 64 of inverter 60. It is to be noted that the illumination device 500 of FIG. 5 can be operated in a similar fashion as described with respect to operation of the illumination device 10 of FIG. 1.

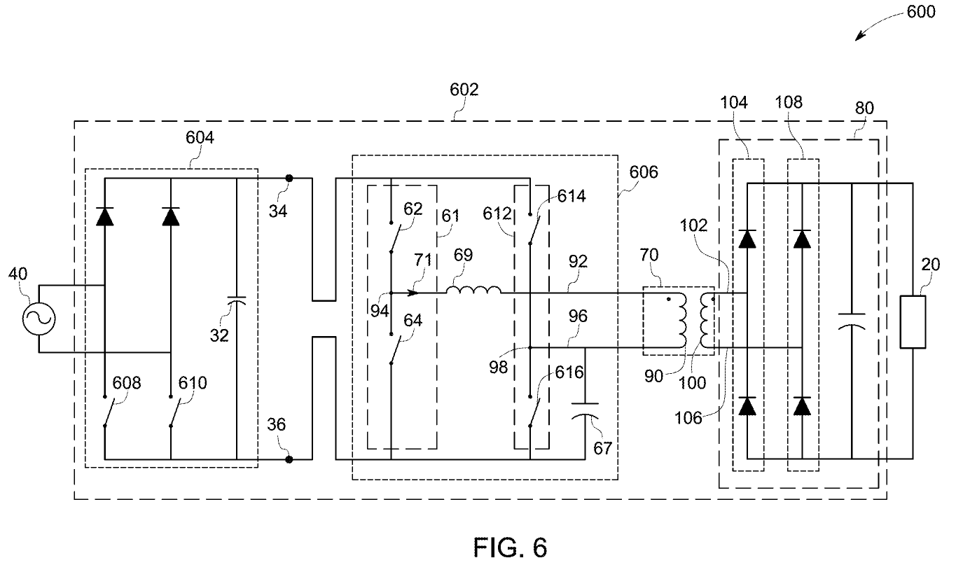

FIG. 6 is a schematic representation of an illumination device 600, in accordance with certain embodiments of the present application. The illumination device 600 includes the load 20, the power source 40, and a CSRC 602. The CSRC 602 is representative of one embodiment of the CSRC 50 of FIG. 1. The power source 40 is coupled to the load 20 via the CSRC 602. The CSRC 602 includes certain sub-systems such as the transformer 70 and the second rectifier 80 that are similar to the corresponding sub-systems used in the CSRC 50 of FIG. 1. The first rectifier 604 and the inverter 606 of the CSRC 602 are different from the first rectifier 30 and the inverter 60 of the CSRC 50. More particularly, the first rectifier 604 of the CSRC 602 includes switches 608 and 610 in the positions of two bottom diodes of the first rectifier 30 of the CSRC 50.

Moreover, the inverter 606 of the CSRC 602 includes two switching legs 61 and 612. As previously noted, the switching leg 61 includes switches 62 and 64. The switching leg 612 includes switches 614 and 616 connected in series. The switches 608, 610, 614, and 616 may be similar to the switches 62, 64. During operation, while the control signal 212 may be applied to the switches 62 and 616, the control signal 214 may be applied to switches 64 and 614. It is to be noted that the illumination device 600 of FIG. 6 can be operated in a similar fashion as described with respect to operation of the illumination device 10 of FIG. 1.

It is to be understood that a skilled artisan will recognize the interchangeability of various features from different embodiments and that the various features described, as well as other known equivalents for each feature, may be mixed and matched by one of ordinary skill in this art to construct additional systems and techniques in accordance with principles of this disclosure. It is, therefore, to be understood that the appended claims are intended to cover all such modifications and changes as fall within the true spirit of the invention.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An illumination device comprising:
a light emitting source; and
a clamped series resonant converter electrically coupled to the light emitting source, wherein the clamped series resonant converter comprises:
a first rectifier configured to generate a direct current (DC) power from an input alternating current (AC) voltage of the first rectifier;
an inverter coupled to the first rectifier and configured to receive the DC power from the first rectifier and generate an intermediate AC power, wherein the inverter comprises:
a switching leg comprising a plurality of switches coupled in series;
a diode leg comprising a plurality of diodes coupled in series, wherein the diode leg is coupled in parallel with the switching leg, wherein the plurality of diodes comprises a first diode and a second diode;
an inductor coupled to the plurality of the switches;
a capacitor coupled in parallel with the second diode to facilitate generation of the intermediate AC power, wherein a voltage across the capacitor is clamped at a level equivalent to a level of a DC voltage at an input of the inverter or zero via the first diode and a second diode; and
a transformer coupled to the inverter, wherein the transformer comprises a primary winding and a secondary winding, wherein the primary winding of the transformer is connected between the inductor and the capacitor, and wherein a voltage developed across the primary winding causes automatic power factor correction by drawing an input current flowing through the clamped series resonant converter that is proportional to the AC voltage.

2. The illumination device of claim 1, wherein the light emitting source comprises a string of one or more light emitting diodes.

3. The illumination device of claim 1, wherein the clamped series resonant converter further comprises a second rectifier coupled to the secondary winding of the transformer, wherein the second rectifier is configured to generate an output DC power.

4. The illumination device of claim 3, wherein light emitting source applies fixed voltage to an output of the clamped series resonant converter, and wherein the the clamped series resonant converter is configured to automatically regulate a load current flowing through the light emitting source to provide a fixed output DC power to the light emitting source.

5. The illumination device of claim 1, wherein switching of the plurality of switches is controlled via control signals applied to respective control terminals of the plurality of switches, wherein a load current flowing through the light emitting source is controlled based on a frequency of the control signals.

6. The illumination device of claim 1, wherein switching of the plurality of switches is controlled via control signals applied to respective control terminals of the plurality of switches, wherein a load current flowing through the light emitting source is controlled based on a duty-cycle of the control signals.

7. The illumination device of claim 1, wherein the clamped series resonant converter comprises a magnetizing inductance induced by the transformer in the clamped series resonant converter when operatively coupled to the light emitting source.

8. The illumination device of claim 7, wherein the magnetizing inductance enables a zero-voltage switching in the clamped series resonant converter.

9. The illumination device of claim 7, wherein the clamped series resonant converter operates in a partial zero-voltage switching mode or a full zero-voltage switching mode.

10. The illumination device of claim 1, wherein the clamped series resonant converter operates in a zero-voltage switching mode upon achieving a zero-current switching boundary condition.

11. A method for operating an illumination device comprising a clamped series resonant converter electrically coupled between a light emitting source coupled to, wherein the clamped series resonant converter comprises an inverter comprising a plurality of switches, the method comprising:
operating the plurality of switches of the inverter of the clamped series resonant converter at a fixed switching frequency for a predetermined time;
drawing an input current by the clamped series resonant converter from a power source in phase with an input voltage supplied by the power source to achieve an automatic power factor correction;
applying a fixed voltage at an output of the clamped series resonant converter by the light emitting source; and
regulating a load current flowing through the light emitting source based on the fixed switching frequency.

12. The method of claim 11, wherein the light emitting source comprises one or more light emitting diodes.

13. The method of claim 11, wherein operating the plurality of switches comprises applying control signals to respective control terminals of the plurality of switches, wherein the control signals comprise pulses of the fixed switching frequency.

14. An illumination device comprising:
a light emitting source; and
a clamped series resonant converter electrically coupled to the light emitting source, wherein the clamped series resonant converter comprises:
a first rectifier configured to generate a direct current (DC) power from an input alternating current (AC) voltage of the first rectifier;
an inverter coupled to the first rectifier and configured to receive the DC power from the first rectifier and generate an intermediate AC power, wherein the inverter comprises:
a plurality of switches;
an inductor coupled to the plurality of the switches;
a capacitor coupled in parallel with one of the plurality of the switches to facilitate generation of the intermediate AC power, wherein a voltage across the capacitor is clamped at a level equivalent to a level of a DC voltage at an input of the inverter or zero; and
a transformer coupled to the inverter, wherein the transformer comprises a primary winding and a secondary winding, wherein the primary winding of the transformer is connected between the inductor and the capacitor, and wherein a voltage developed across the primary winding causes automatic power factor correction by drawing an input current flowing through the clamped series resonant converter that is proportional to the AC voltage.

15. The illumination device of claim 14, wherein the plurality of switches are arranged in a first switching leg and a second switching leg coupled in parallel with each other.

16. The illumination device of claim 15, wherein the inductor is coupled to a node between at least two switches of the first switching leg.

17. The illumination device of claim 15, wherein the capacitor is coupled in parallel with one switch of the second switching leg.
